(19) United States
(12) Patent Application Publication
(10) Pub. No.: US 2005/0019040 A1
(43) Pub. Date: Jan. 27, 2005

(54) Optical communication system and method using spread-spectrum encoding

(76) Inventor: William R. Trutna JR., Atherton, CA (US)

Correspondence Address: AGILENT TECHNOLOGIES, INC.;Legal Department, DL429, Intellectual Property Administration, P.O. Box 7599, Loveland, CO, 80537-0588, US

(21) Appl. No.: 10/626,446

(22) Filed: Jul. 24, 2003

(51) Int. Cl. H04B 10/04

(52) U.S. Cl. 398/183

(57) ABSTRACT

Using spread-spectrum encoding the spread the spectrum of information signals transmitted in an optical communications system enables significantly higher levels of inter-channel interference to be tolerated than in conventional optical communication systems. This allows the bandwidth of the optical channels of the optical communication system to be increased, and the bit rate of the channels to be increased. Applying spread-spectrum encoding to the information signals increases the bit rate of each information signal by a factor of L, but significantly more than L spread-spectrum information signals can be transmitted in the same optical channel and can be successfully recovered at the receiver. Accordingly, using spread spectrum encoding provides a significant increase in the capacity of the optical communication system.

### TECHNICAL FIELD OF THE INVENTION

The invention relates to communications and, more particularly, to using spread-spectrum encoding in conjunction with optical wavelength division multiplexing (WDM) to increase the data capacity of an optical communication system.

### BACKGROUND OF THE INVENTION

Wavelength division multiplexing (WDM) systems are employed in optical communication systems to enable information to be transmitted at multiple wavelengths over a single optical fiber, thereby increasing the amount of information that can be transmitted. The theoretical minimum optical loss for glass fiber is about 0.16 decibels per kilometer (dB/km), and this theoretical minimum occurs at a wavelength of about 1550 nanometers (nm). Erbium-doped amplifiers, which currently are the most common type of amplifier used for amplifying optical signals carried on optical fibers, perform best in the wavelength range of approximately 1520 to 1565 nm. Therefore, these amplifiers have the best gain characteristics over a wavelength range that includes the wavelength at which optical attenuation in optical fibers is at a minimum.

FIG. 1 illustrates a graph 1 on which two curves 10 and 11 are plotted. The axis labeled FIBER LOSS IN DECIBELS (dB) of graph 1 corresponds to the optical loss in decibels (dB) for a typical transmission optical fiber as a function of transmission wavelength. The axis labeled AMPLIFIER GAIN IN DECIBELS (dB) corresponds to the optical gain in decibels (dB) for a typical erbium-doped amplifier as a function of transmission wavelength. Curve 10 represents optical loss as a function of wavelength for a typical optical fiber. Curve 11 represents gain as a function of wavelength for a typical erbium-doped amplifier.

The shapes of curves 10 and 11 are not intended to illustrate precise relationships between loss of a fiber versus wavelength and between gain of an erbium-doped amplifier versus wavelength, respectively. Rather, curves 10 and 11 are intended to illustrate the approximate relationship between the loss and gain characteristics of a typical transmission fiber and a typical erbium-doped amplifier, respectively.

The shape of plot 11 in the graph 1 indicates that a typical erbium-doped amplifier has its highest gain in a wavelength window that is approximately 43 nm wide. This window includes the 1550 nm wavelength and wavelengths slightly less than and greater than 1550 nm. The shape of plot 11 also indicates that the gain of the erbium-doped amplifier drops off rapidly outside the 43 nm-wide window. The shape of plot 10 indicates that the optical fiber has its lowest optical loss at approximately 1550 nm. Therefore, optimum optical performance is obtained in an optical communication system by using transmission wavelengths within the 43 nm-wide window. Two other windows exist that are used less commonly than the 43 nm window. These are the long band (L-band) and short band (S-band) windows. For illustrative purposes, only the 43 nm-wide window at approximately 1550 nm will be discussed herein due to the fact that the majority of optical fiber communications occur within this window.

The ability of WDM systems and techniques to increase the capacity of optical communication systems is limited by the constraint on usable transmission wavelengths. In addition, the transmission wavelengths that are used must be spaced apart by a sufficient amount to prevent interference between the optical signals in adjacent channels. This spacing decreases the number of usable transmission wavelengths, thereby further limiting capacity.

In optical communication systems employing WDM, the above-mentioned 43 nm-wide window is typically divided into 80 channels, i.e., transmission wavebands, each with a bit rate of 10 Gigabits per second (Gb/s). Each channel has a bandwidth of 50 Gigahertz (GHz). The 80 channels collectively occupy a frequency range of approximately 4,000 GHz, i.e., 80 channels×50 GHz. The aggregate bit rate when all channels are used is 800 Gb/s, i.e., 80 channels×10 Gb/s. A good figure of merit for the spectral efficiency of an optical communication system is the bit rate divided by the bandwidth of the system. The 80-channel system, therefore, has a figure of merit equal to approximately ((80×10 Gb/s)/(4,000 GHz)) or 0.20 bits.sec⁻¹/Hz. This figure of merit is very close to the limit of what can be achieved with current WDM systems, which is a practical limit dictated by a number of factors including laser drift and drift of the optical filter used in the WDM demultiplexer.

Optical filters are used in the wavelength division demultiplexer of the receiver to separate the WDM channels at the receiver and prevent interference between adjacent channels. However, the optical filters that are currently used in such systems have a pass bandwidth of approximately 30 GHz, which is much less than the channel spacing of 50 GHz. Wider filter bandwidths would produce unacceptable levels of inter-channel interference because of the gradual roll-off of the out-of-band rejection characteristic. In addition, factors such as temperature drift of both the laser frequency and the center frequency of the filter, aging of the filter components, etc., further reduce the usable bandwidth of the channel. The combination of these factors limits the maximum bit rate per channel in such systems to the 10 Gb/s rate mentioned above. This rate is small compared with the bandwidth of the channels.

A need exists for a way to increase the capacity of an optical communication system.

### SUMMARY OF THE INVENTION

The information signals to be transmitted through an optical communication system are subject to spread-spectrum encoding prior to transmission and the spread-spectrum optical signal is decoded to recover the information signals at the receiver. Using spread-spectrum encoding to spread the spectrum of information signals enables significantly higher levels of inter-channel interference to be tolerated than in conventional optical communications systems. The higher allowable levels of inter-channel interference allow the bandwidth of the optical channels of the optical communication system to be increased. This in turn allows the bit rate of the channels to be increased significantly.

Applying spread-spectrum encoding to the information signals increases the bandwidth requirement for each information signal by a factor of L, where L is the ratio of the chip rate of the spread-spectrum information signal to the bit rate of the original information signal. However, significantly more than L spread-spectrum information signals can be transmitted in the same optical channel and can be successfully recovered at the receiver. Accordingly, using spread spectrum encoding provides a significant increase in the capacity of the optical communication system.

The invention provides an optical communication system for communicating one or more information signals. In one aspect, the optical communication system includes an optical transmitter that includes spread-spectrum encoders corresponding in number to the information signals, a light source and a modulator system. The spread-spectrum encoders are operable to multiply the information signals by respective pseudo-noise (PN) code sequences to generate respective spread-spectrum information signals. The modulator system is for modulating light generated by the light source in response to the spread-spectrum information signals to generate a spread-spectrum optical signal for transmission. The spread-spectrum optical signal has an amplitude modulation representative of the sum of the spread-spectrum information signals.

In an embodiment, the optical communication system includes additional ones of the optical transmitters and a wavelength division multiplexer. The light sources of the optical transmitters generate light at respective different wavelengths. The wavelength division multiplexer is arranged to receive the spread-spectrum optical signals from the optical transmitters and is operable to multiplex the spread-spectrum optical signals for transmission.

In another aspect, the optical communication system includes an optical receiver that includes an optical detector and at least one spread-spectrum decoder. The optical detector is arranged to receive a spread-spectrum optical signal that represents at least one spread-spectrum information signal. Each spread-spectrum information signal has a spectrum spread by a respective pseudo-noise (PN) code sequence. The optical detector is operable to generate a spread-spectrum electrical signal in response to the spread-spectrum optical signal. The at least one spread-spectrum decoder is connected to receive the spread-spectrum electrical signal from the optical detector. Each spread-spectrum decoder is operable to despread the spectrum of one of the spread-spectrum information signals represented by the spread-spectrum electrical signal to recover a corresponding information signal.

In an embodiment, the optical communication system additionally includes a wave-division demultiplexer and additional ones of the optical receivers. The wavelength division multiplexer is arranged to receive a WDM optical signal that includes spread-spectrum optical signals having different carrier wavelengths The wave-division demultiplexer is operable to spatially separate the spread-spectrum optical signals constituting the WDM optical signal from one another. The optical receivers are each arranged to receive a different one of the spread-spectrum optical signals from the wave-division demultiplexer.

The invention also provides an optical communication method. In one aspect, the optical communication method includes performing a spread-spectrum optical signal generating process. In the spread-spectrum optical signal generating process, information signals are received, orthogonal or quasi orthogonal pseudo-noise (PN) code sequences are generated, each of the information signals is multiplied by a respective one of the PN code sequences to generate a respective spread-spectrum information signal, light is generated, and the light is modulated in response to the spread-spectrum information signals to generate for transmission a spread-spectrum optical signal having an amplitude modulation representative of the sum of the spread-spectrum information signals.

In an embodiment, the optical communication method additionally includes performing additional ones of the spread-spectrum optical signal generating process to generate respective spread-spectrum optical signals having different carrier wavelengths, and wavelength division multiplexing the spread-spectrum optical signals having the different carrier wavelengths to generate a wavelength-division multiplexed optical signal for transmission.

In another aspect, the optical communication method includes performing a spread-spectrum optical signal receiving process. In the spread-spectrum optical signal receiving process, a spread-spectrum optical signal is received. The spread-spectrum optical signal represents spread-spectrum information signals each having a spectrum spread by a respective pseudo-noise (PN) code sequence. The spread-spectrum optical signal is converted to a spread-spectrum electrical signal. Spread-spectrum decoding is applied to the spread-spectrum electrical signal, including using a corresponding PN code sequence to despread the spectrum of each of the spread-spectrum information signals represented by the spread-spectrum electrical signal to recover a respective one of the information signals.

In an embodiment the optical communication method additionally includes receiving a WDM optical signal including spread-spectrum optical signals having respective different carrier wavelengths, demultiplexing the WDM optical signal to recover the spread-spectrum optical signals, and performing the spread-spectrum optical signal receiving process on each of the spread-spectrum optical signals.

Other features and advantages of the invention will become apparent from the following description, drawings and claims.

### BRIEF DESCRIPTION OF THE DRAWINGS

FIG. 1 is a graph illustrating an exemplary gain-versus-wavelength characteristic of an erbium-doped amplifier and an exemplary loss-versus-wavelength characteristic of an optical fiber.

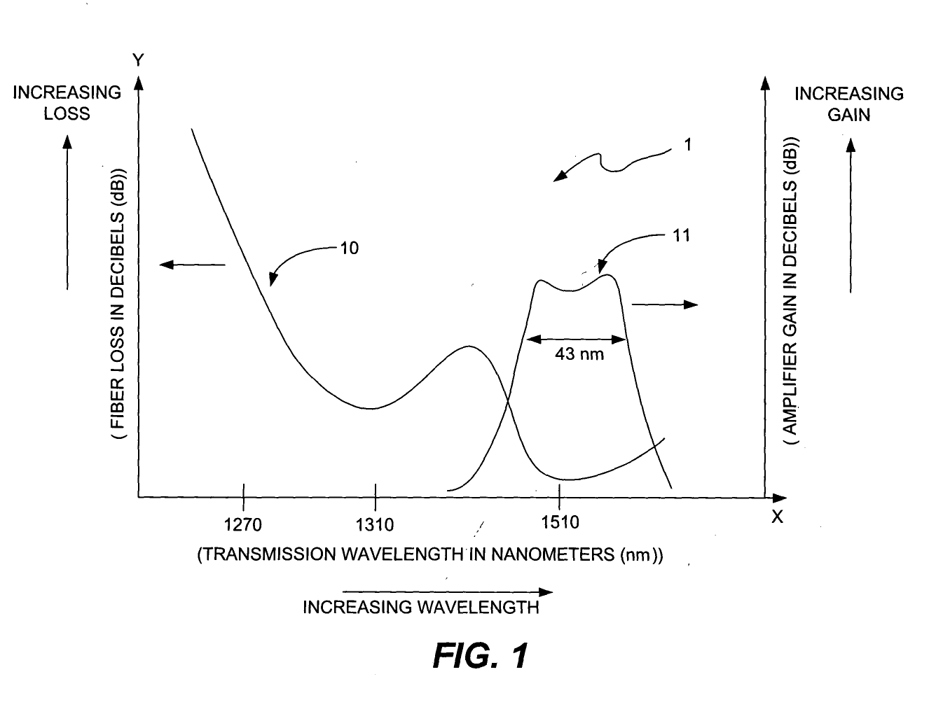

FIG. 2 is a block diagram of an optical communication system in accordance with an exemplary embodiment of the invention showing details of the transmitter.

FIG. 3 is a block diagram of an optical communication system in accordance with an exemplary embodiment of the invention showing details of the receiver.

FIG. 4 is a block diagram of the transmitter of an optical communication system in accordance with an exemplary embodiment of the invention in which spread-spectrum encoding is applied in multiple electrical channels and multiple optical channels.

FIG. 5 is a block diagram of the receiver of an optical communication system in accordance with an exemplary embodiment of the invention in which spread-spectrum decoding is applied in multiple electrical channels and multiple optical channels.

FIG. 6 is a block diagram of a transmitter of an optical communication system in accordance with another embodiment of the invention in which the spread-spectrum information signals are summed in the optical domain.

FIG. 7 is a block diagram of a transmitter of an optical communication system in accordance with another embodiment of the invention in which the spread-spectrum information signals directly modulate respective lasers.

FIG. 8 is a flow chart illustrating an optical communication method in accordance with the invention in which a spread-spectrum optical signal generating process is performed.

FIG. 9 is a flow chart illustrating an optical communication method in accordance with the invention in which a spread-spectrum optical signal receiving process is performed.

### DETAILED DESCRIPTION OF THE INVENTION

The invention uses spread-spectrum encoding in conjunction with wavelength division multiplexing (WDM) to increase the capacity of an optical communication system. As stated above, increasing bit rate in a conventional optical WDM communication system, which requires increasing the pass bandwidths of the channel filters, causes increased inter-channel interference. Such increased inter-channel interference is usually not allowable in conventional optical WDM communication systems. For these reasons, conventional optical WDM communication systems are not able to satisfy demand for greater capacity.

As stated above, the current 80 channel, 10 Gb/s per channel WDM optical communication system has a capacity that is very near the maximum achievable capacity due to practical limitations imposed by parameters such as laser drift and drift of the center frequency of the demultiplexing filters. The invention provides a way to increase the capacity of an optical WDM communication system.

In accordance with the invention, spread-spectrum encoding is used to increase the immunity of the optical WDM communication system to inter-channel interference. By increasing the immunity of the system to inter-channel interference, the pass bandwidth of the optical filters can be increased, which allows the bit rate to be increased. This increases the overall capacity of the optical communication system.

The invention is not limited to any particular type of optical communication system, and can be applied to any type of optical communication system in which information signals are communicated optically. For purposes of example, the invention will be described with reference to examples of optical communication systems based on optical fibers. However, the invention is not limited to optical communication systems based on optical fibers and can be used in any type of optical communication system.

Although spread-spectrum technology has long been used in wireless communication systems, spread-spectrum technology has not been employed in optical communication systems, such as those based on optical fibers. As stated above, optical communication systems currently use WDM technology to increase their data capacity. In accordance with the invention, a further increase in the capacity of an optical WDM communication system can be achieved by applying spread-spectrum technology to an optical WDM communication system.

The basic idea behind spread-spectrum technology, and, specifically, direct sequence spread-spectrum technology, is that multiple information signals can be transmitted in the same channel, i.e., wavelength band, by spreading the spectrum of each information signal. The spectrum of each information signal is spread by multiplying the information signal by a respective spreading code prior to transmission. Each information signal is multiplied by a different spreading code. The resulting spread spectrum information signals are transmitted in the same channel. The spectrum of each spread-spectrum information occupies the entire bandwidth of the channel. At the receiver, the spectrum of each spread-spectrum information signal is despread to recover the original information signal. Despreading is performed by multiplying the received signal by the spreading code that was used to spread the spectrum of one of the information signals at the transmitter. The spreading code is aligned with the spread-spectrum information signal included in the received signal. The result of the multiplication is integrated over the period of the information signal and the integrated signal is subject to thresholding. The multiplication, integration and thresholding processes despread the spectrum of the received spread-spectrum information signal to its original bandwidth, i.e., the bandwidth of the information signal prior to spreading and recover the original information signal. A similar process is performed using respective spreading codes to recover the remaining information signals represented by the received signal.

One known type of spreading code is called a pseudo-noise (PN) code sequence. A PN code sequence is a sequence of binary 1s and 0s distributed in such a way to make the sequence appear to be truly random. In other words, a PN code sequence has an equal distribution of binary 1s and 0s and an equal distribution of consecutive binary 1s followed by consecutive binary 0s, and vice versa. Using a different PN code sequence to code each information signal transmitted in a given channel enables multiple spread-spectrum information signals to be transmitted in the same channel and the original information signals to be recovered from the received spread-spectrum signal. The PN code sequences for the different information signals are normally orthogonal or quasi-orthogonal to each other to ensure high degree of correlation between matching PN code sequences and no correlation, or a very low degree of correlation between PN code sequences that do not match. This, in turn, ensures very good interference immunity between different spread-spectrum information signals. Moreover, using PN code sequences that are mutually orthogonal or quasi-orthogonal to code the information signals transmitted in adjacent channels provides good interference immunity between the spread-spectrum information signals in the adjacent channels. This increase inter-channel interference immunity in turn allows the bandwidth of the optical filters to be increased and the bit rate of the channels to be increased. Quasi-orthogonal PN code sequences are PN code sequences that are not orthogonal to one another but that nevertheless have narrow autocorrelation peaks. Shift register sequences are quasi-orthogonal PN code sequences.

During spreading, the PN code sequences are produced at the transmitter by a pseudorandom binary sequence generator. At the receiver, a given PN code sequence that was used during spreading is duplicated by a pseudorandom binary sequence generator. The PN code sequence generated in the receiver is synchronized to and cross-correlated with the PN code sequence of the received spread-spectrum information signals at the receiver by a cross-correlator. When the PN code sequences match, the original information signal is recovered as a result of the cross-correlation.

Each bit in a PN code sequence is called a chip and the rate at which the chips of a PN code sequence are generated is known as the chip rate. The chip rate is many times greater than the bit rate of the information signal. Each PN code sequence has a particular length, and typically comprises a very large number of chips. Some spread-spectrum techniques use a fixed-length PN code that is repeated, whereas other spread-spectrum techniques use extremely long codes that are viewed as being virtually infinite. In the latter case, each PN code sequence will comprise a different portion of the PN code. For purposes of illustration, it will be assumed that the spread-spectrum coding applied in accordance with the invention uses fixed length PN code sequences that are repeated. However, the invention can alternatively use virtually infinite PN codes.

Each bit of the information signal is coded by multiplying it by a predetermined number of the chips of the PN code sequence. In an example, each bit of the information signal is coded by multiplying it by 64 chips of the PN code. The receiver performs a cross-correlation algorithm that aligns the received spread-spectrum information signal with the PN code sequence assigned to the spread-spectrum information signal, multiplies the received spread-spectrum information signal by the assigned PN code sequence, integrates the products of the multiplication and thresholds the integration results to recover the original information signal. The integration will produce a result of zero, or very close to zero, when the PN code sequence does not match the PN code sequence used to code the received spread-spectrum information signal. When the code sequences match, thresholding the integration results recovers the original information signal.

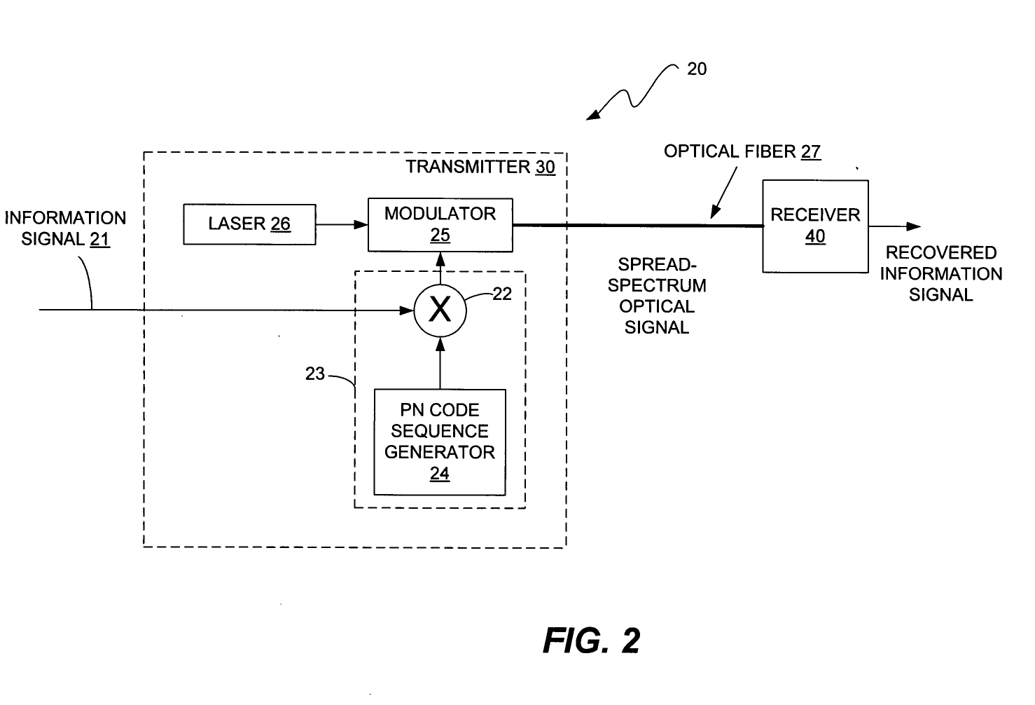

Having described spread-spectrum technology in general, the manner in which it is used in accordance with the invention to increase the data capacity of an optical communication system will now be described. FIG. 2 is a block diagram of an optical communication system 20 of the invention in accordance with an exemplary rudimentary embodiment in which only a single information signal is transmitted. In accordance with this embodiment, the optical communication system 20 communicates via an optical fiber. The optical communication system 20 is composed of a transmitter 30, a receiver 40 and an optical fiber 27 that extends from the transmitter 30 to the receiver 40.

The transmitter 30 is composed of a spread-spectrum encoder 23, a light source 26 and a modulator 25 that modulates light generated by the light source. The spread-spectrum encoder 23 is composed of a multiplier 22 and a PN code sequence generator 24. The light source 26 is composed of a continuous-wave (CW) laser. The spread-spectrum encoder 23 multiplies an information signal 21 by a pseudo-noise (PN) code sequence to produce a spread-spectrum information signal. In the spread-spectrum encoder 23, the multiplier 22 receives the information signal 21 to be transmitted and a PN code sequence generated by the PN code sequence generator 24. The multiplier 22 multiplies the information signal 21 by the PN code sequence to spread the spectrum of the information signal 21 and thereby generate the spread-spectrum information signal. The spread-spectrum information signal is delivered to the modulator 25. The modulator 25 additionally receives a beam of light from the laser 26 and modulates the amplitude of the beam of light in response to the spread spectrum information signal to provide a spread-spectrum optical signal for transmission. The spread-spectrum optical signal, which has an amplitude modulation that represents the spread-spectrum information signal, passes from the modulator 25 into the optical fiber 27 for transmission to the receiver 40.

In some optical communication systems, the information signal 21 may be generated by a symbol generator (not shown) and may additionally have been subject to interleaving and to coding for error detection/correction. The symbol generator receives a raw information signal and generates symbols that represent the raw information signal. Each symbol represents one bit of the raw information signal and each symbol can be made up of one or more bits. Symbol encoding is used to make the transmission less susceptible to burst errors and is known in the art. A symbol generator and other signal processing circuitry can be incorporated into the transmitter 30 if desired, although not all embodiments of the invention will employ symbol generation, interleaving and coding for error detection/correction to generate the information signal 21.

FIG. 2 only shows a part of the transmitter of a typical optical communication system in accordance with the invention. In accordance with an embodiment of the invention, multiple information signals are transmitted in the same optical channel of the optical communication system by spreading the spectrum of each information signal with a different PN code sequence to generate a respective spread-spectrum information signal. Light from the light source of a wavelength corresponding to the optical channel is modulated in response to the spread spectrum information signals to provide a spread-spectrum optical signal for transmission. The spread-spectrum optical signal has an amplitude modulation that represents the sum of the spread-spectrum information signals.

Moreover, optical communication system 20 can employ wavelength division multiplexing in which multiple spread-spectrum information signals are transmitted in each optical channel of the multi-channel optical communication system. In one embodiment, the PN code sequences used to spread the spectrum of all the information signals are mutually orthogonal or quasi-orthogonal. In another embodiment, at least the PN code sequences used to encode all the information signals transmitted in adjacent optical channels are mutually orthogonal or quasi-orthogonal. Using mutually orthogonal or quasi-orthogonal PN code sequences mitigates the effects of adjacent channel interference, which allows the bandwidth of the optical channels and, hence, the bit rate, to be increased. Examples of such embodiments will be described below.

In the exemplary embodiment shown in FIG. 2, the transmitter 30 and the receiver 40 communicate via an optical fiber, which may be a single optical fiber. The optical communication system may also include one or more repeater amplifiers (not shown) placed along the optical fiber at various locations to compensate for optical attenuation. This is especially applicable in terrestrial and transoceanic optical communication system in which the signals travel great distances. Typically, a repeater is needed every 100 kilometers (km) of optical fiber. However, the present invention also is suitable for use in applications where optical communication occurs over relatively short distances and signal degradation caused by attenuation of the optical signal generally is not an issue.

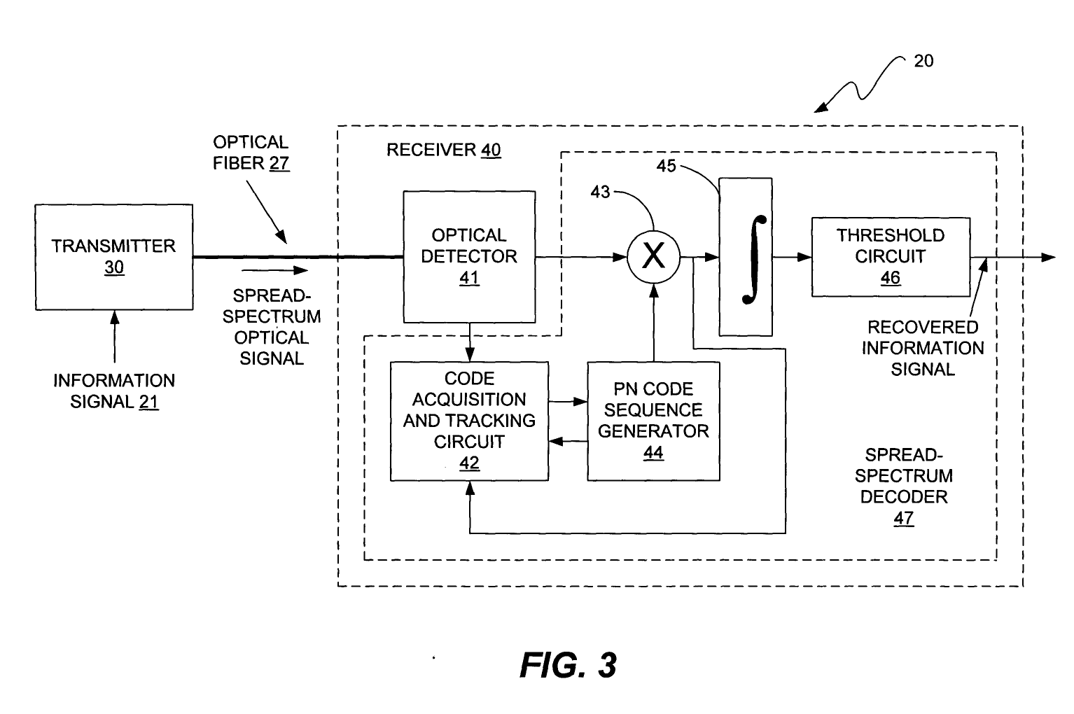

FIG. 3 is a block diagram of the optical communication system 20 shown in FIG. 2 with the transmitter 30 shown as a single block and with the receiver 40 shown in detail. Optical receiver 40 is composed of an optical detector 41 and a spread-spectrum decoder 47. The spread-spectrum decoder 47 is composed of a PN code acquisition and tracking circuit 42, a PN code sequence generator 44, an integrator 45 and a threshold circuit 46. In the receiver 40, the optical detector 41 receives the spread-spectrum optical signal transmitted by the transmitter 30 via the optical fiber 27 and converts the spread-spectrum optical signal into a spread-spectrum electrical signal that can be processed by the spread-spectrum decoder 47. The spread-spectrum decoder 47 despreads the spectrum of the spread-spectrum information signal represented by the spread-spectrum electrical signal to recover the original information signal.

In the spread-spectrum decoder 47, the spread-spectrum electrical signal output from optical detector 41 is received by PN code acquisition and tracking logic 42 and the multiplier 43. The PN code acquisition and tracking logic 42 also receives the PN code sequence assigned to the receiver 40 from the PN code sequence generator 44. The PN code acquisition and tracking logic 42 performs a search algorithm that steps the PN code sequence generator 44 sequentially and analyzes the cross-correlation result output by the multiplier 43 to determine when a correlation value is obtained that indicates alignment between the PN code sequence generated by the PN code sequence generator and the PN code sequence that forms part of the spread-spectrum electrical signal generated by the optical detector 41. The multiplier 43 multiplies the spread-spectrum electrical signal and the aligned PN code sequence, which despreads the spectrum of the spread-spectrum electrical signal to generate a despread information signal. The integrator 45 integrates the despread information signal over the bit period of the original information signal.

The threshold circuit 46 compares the integrated signal to a threshold value to determine whether each level of the integrated signal corresponds to that of a binary 1 or a binary 0. The threshold circuit helps eliminate the noise that results from multiple spread-spectrum information signals being transmitted in the same optical channel and also helps eliminate the noise that results from inter-channel interference. The output of the threshold circuit 46 is an electrical signal that represents the original information signal.

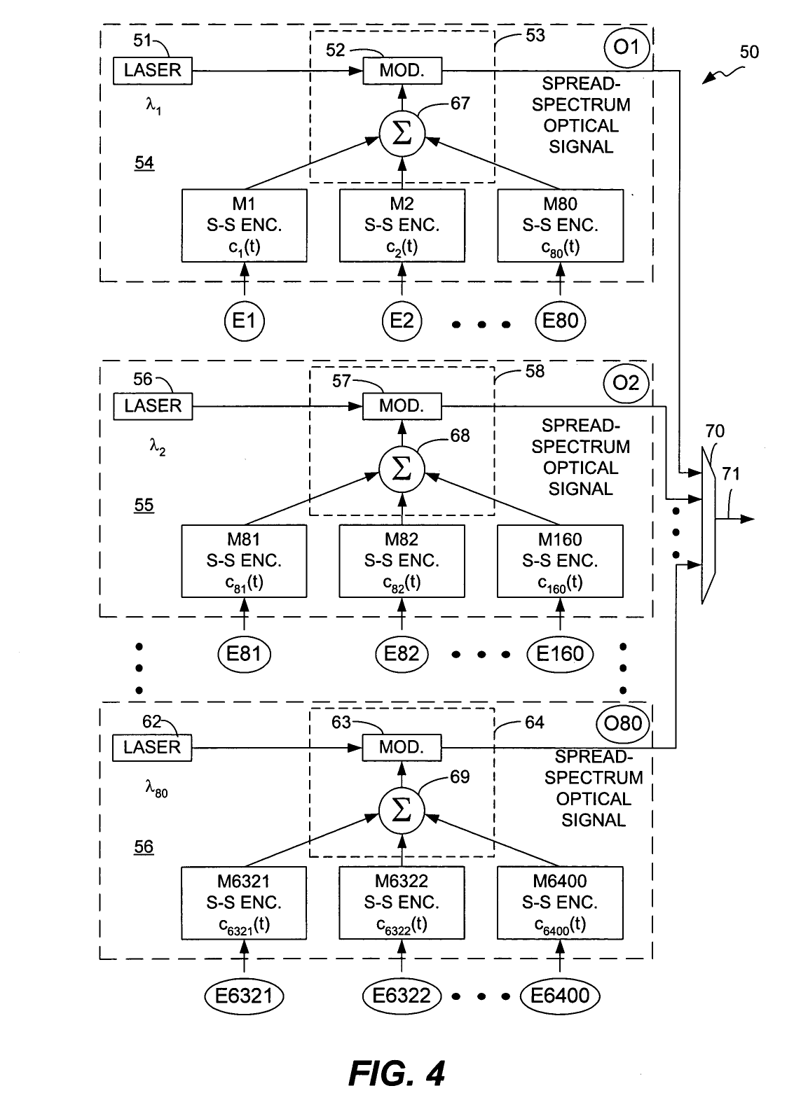

FIG. 4 is a block diagram of the transmitter portion 50 of an optical WDM communication system of the invention in accordance with an exemplary embodiment in which multiple information signals are transmitted in each of multiple optical channels. In this example, the transmitter portion 50 is the transmitter of an optical WDM communication system that has eighty optical channels and in which each of the optical channels carries eighty spread-spectrum information signals.

The transmitter portion 50 is composed of eighty optical transmitters each of which includes a laser that generates an optical carrier signal at a different wavelength corresponding to the center wavelength of a different one of the optical channels. The eighty optical carriers at wavelengths, λ₁, λ₂, . . . , λ₈₀, are each modulated in response to the sum of eighty spread-spectrum information signals to transmit as many as 6,400 information signals over an optical fiber or other optical path to a WDM receiver. Therefore, FIG. 4 shows the transmitter portion 50 of an optical channel WDM communication system having 80 optical channels and 6,400 electrical channels. To simplify the drawing, FIG., 4 shows the optical transmitters 54, 55 and 56 of only three of the eighty optical channels and shows only three of the eighty electrical channels of the three optical transmitters shown. The invention is not limited with respect to the number of electrical channels, the number of optical channels and the number of electrical channels per optical channel.

In the embodiment shown in FIG. 4, each of the optical transmitters 54, 55 and 56 includes a laser and circuits for multiplying multiple information signals by respective PN code sequences, summing the respective spread-spectrum information signals and amplitude modulating the light generated by the laser with the sum of the spread-spectrum information signals for transmission. In accordance with this embodiment, each carrier wavelength is modulated with the sum of the spread-spectrum signals generated from respective multiple information signals to provide increased transmission bandwidth.

Each optical transmitter 54, 55 and 56 generates the spread-spectrum optical signal for one optical channel. The spread-spectrum optical signals each have a different wavelength and are subject to wave division multiplexing prior to transmission via a single optical fiber. Each optical channel is identified by a circle enclosing the letter “O” and the optical channel number. In this example, eighty information signals are transmitted in each optical channel, i.e., a total of 6,400 information signals are transmitted in this example. Each information signal is processed by circuits that constitute a respective electrical channel. Each electrical channel is identified by a circle enclosing the letter “E” and the electrical channel number. As noted above, only three electrical channels of the three optical transmitters are shown.

In optical transmitter 54 for optical channel O1 of wavelength λ₁, electrical channels E1, E2 and E80 are shown. The ellipses between electrical channels E2 and E80 represent electrical channels E3 through E79 that are not shown. In optical transmitter 55 for optical channel O2 of wavelength λ₂, three electrical channels E81, E82 and E160 are shown. The ellipses between electrical channels E82 and E160 represent electrical channels E83 through E159 that are not shown. In optical transmitter 56 for optical channel O80 of wavelength λ₈₀, electrical channels E6321, E6322 and E6400 are shown. The ellipses between electrical channels E6322 and E6400 represent electrical channels E6323 through E6399 that are not shown. The ellipses between optical channels O2 and O80 represent the optical transmitters of optical channels O3 through O79 of wavelengths λ₃ through λ₇₉, respectively, and electrical channels E161 through E6320 that are not shown.

The optical carrier signal in each of the optical channels O1, O2, . . . , O80 is modulated by the sum of eighty spread-spectrum information signals. Therefore, in this example, as many as 6,400 information signals in 6,400 electrical channels are simultaneously transmitted in 80 optical channels.

In optical transmitter 54 of optical channel O1, each of the electrical channels E1-E80 receives a respective information signal and includes a respective spread-spectrum encoder M1-M80 similar in structure to the spread-spectrum encoder 23 described above with reference to FIG. 2. The spread-spectrum encoders M1-M80 multiply the information signals they receive by the mutually orthogonal or pseudo-orthogonal PN code sequences c(t)₁ through c(t)₈₀ respectively assigned to the encoders to produce respective spread-spectrum information signals. The spread-spectrum information signals pass to a modulator system 53 that operates in response to the spread-spectrum information signals to modulate light generated by the laser 51 to generate the spread-spectrum optical signal for transmission. The spread-spectrum optical signal has an amplitude modulation representative of the sum of the spread-spectrum information signals generated by spread-spectrum encoders M1-M80.

The modulator system 53 is composed of an analog summer 67 and a modulator 52. The analog summer 67 sums the spread-spectrum information signals output by the spread-spectrum encoders M1-M80 to generate an analog modulation signal. The modulator 52 receives the CW light beam from the laser 51 and the analog modulation signal from the analog summer 67. The modulator modulates the light in response to the analog modulation signal to produce the spread-spectrum optical signal for optical channel O1. The spread-spectrum optical signal for optical channel O1 passes to an optical multiplexer 70, which multiplexes the spread-spectrum optical signals for optical channels O1, O2, . . . , O80 received from modulators 52, 57, . . . 63 for transmission over optical fiber 71.

In optical transmitter 55 of optical channel O2, each of the electrical channels E81-E160 receives a respective information signal and includes a respective spread-spectrum encoder M81-M160 each similar in structure to the spread-spectrum encoder 23 described above with reference to FIG. 2. The spread-spectrum encoders M81-M160 multiply the information signals they receive by the mutually orthogonal or pseudo-orthogonal PN code sequences c₈₁(t) through c₁₆₀(t) respectively assigned to the encoders to produce respective spread-spectrum information signals. The spread-spectrum information signals pass to a modulator system 58 that operates in response to the spread-spectrum information signals to modulate light generated by the laser 56 to generate a spread-spectrum optical signal for transmission. The spread-spectrum optical signal has an amplitude modulation representative of the sum of the spread-spectrum information signals generated by spread-spectrum encoders M81-M160.

The modulator system 58 is composed of an analog summer 68 and a modulator 57. The analog summer 68 sums the spread-spectrum information signals output by spread-spectrum encoders M81-M160 to generate an analog modulation signal. The modulator 57 receives the CW light beam from the laser 56 and the analog modulation signal from the analog summer 68. The modulator modulates the light in response to the analog modulation signal to produce the spread-spectrum signal optical for optical channel O2. The spread-spectrum optical signal for optical channel O2 passes to optical multiplexer 70, which, as stated above, multiplexes the spread-spectrum optical signals for optical channels O1, O2, . . . , O80 received from modulators 52, 57, . . . , 63 for transmission over fiber 71.

In optical transmitter 56 of optical channel O80, each of the electrical channels E6321-E6400 receives a respective information signal and includes a respective spread-spectrum encoder M6321-M6400 each similar in structure to the spread-spectrum encoder 23 described above with reference to FIG. 2. The spread-spectrum encoders M6321-M6400 multiply the information signals they receive by the mutually orthogonal or pseudo-orthogonal PN code sequences c₆₃₂₁(t) through c₆₄₀₀(t) respectively assigned to the encoders to produce respective spread-spectrum information signals. The spread-spectrum information signals pass to a modulator system 64 that operates in response to the spread-spectrum information signals to modulate light generated by the laser 62 to generate a spread-spectrum optical signal for transmission. The spread-spectrum optical signal has an amplitude modulation representative of the sum of the spread-spectrum information signals generated by spread-spectrum encoders M6321-M6400.

The modulator system 64 is composed of an analog summer 69 and a modulator 63. The analog summer 69 sums the spread-spectrum information signals output by spread-spectrum encoders M6321-M6400 to generate an analog modulation signal. The modulator 63 receives the CW light beam from the laser 62 and the analog modulation signal from the analog summer 69. The modulator modulates the light in response to the analog modulation signal to produce the spread-spectrum signal optical for optical channel O80. The spread-spectrum signal optical for channel O80 passes to optical multiplexer 70, which, as stated above, multiplexes the spread-spectrum optical signals for optical channels O1, O2, . . . , O80 received from modulators 52, 57, . . . , 63 for transmission over fiber 71.

The modulator systems 53, 58 and 64 described above modulate the light generated by lasers 51, 56, and 62, respectively, using modulators 52, 57 and 63, respectively. In another embodiment, modulators 52, 57 and 63 are omitted and the lasers 51, 56, and 62 are directly modulated by the analog modulation signals output by analog summers 67, 68 and 69, respectively. In this embodiment, the analog modulation signals are connected directly to modulation inputs (not shown) of the respective lasers.

Although 6,400 different PN code sequences are used in this example, fewer code sequences can be used since interference between nonadjacent channels is low in practical systems. For example, in an embodiment in which 240 mutually orthogonal code sequences are grouped into 3 sets of 80 labeled A, B, and C, code sequence set A is assigned to the spread-spectrum encoders M1-M80 of optical channel O1 code sequence set B is assigned to the spread-spectrum encoders M81-M160 of optical channel O2 and code sequence set C is assigned to the spread-spectrum encoders M161-M240 of optical channel O3. This sequence of code sequence set assignments is repeated in ABC order until code sequence sets have been assigned to the spread-spectrum encoders of all 80 optical channels. Although code sequence set A is assigned to both optical channels O1 and O4, these optical channels are spaced far enough apart in wavelength that interference between the optical signals in these channels is unlikely. A similar situation applies to all other wavelengths and code sequence sets.

As stated above, in this example, the maximum number of information signals that can be transmitted simultaneously in the example shown is 6,400 (80 information signals/optical channel×80 optical channels=6,400 information signals), whereas in conventional 80-channel optical WDM systems, only eighty information signals are transmitted. However, the bit rate of each information signal transmitted in the optical WDM communication system in accordance with the invention is less than that of the information signals transmitted in conventional optical WDM communication systems. For an optical channel having a given bit rate, the bit rate of each information signal is about 1/L of that of the information signals transmitted in the conventional optical WDM communication system, where L is the length of the PN code sequence used to encode each bit of the information signal. The bit rate of the information signals reduced because the bit rate of the spread-spectrum optical signal in each optical channel in the optical WDM communication system in accordance with the invention is determined by the chip rate of the spread-spectrum information signals rather than the bit rate of the original information signal. Nevertheless, the cumulative bit rate of all the information signals transmitted in each optical channel of the optical WDM communication system in accordance with the invention is significantly greater than the bit rate of the information signal transmitted in each optical channel of a conventional optical WDM system.

Each optical channel of the optical WDM communication system in accordance with the invention is able to transmit a greater cumulative bit rate than the optical channels of a conventional optical WDM communication system because spreading the spectrum of the information signals using mutually orthogonal PN code sequences before transmission provides interference immunity between the spread-spectrum information signals transmitted in adjacent channels. This in turn allows the spread-spectrum optical signal transmitted in each optical channel to occupy the a greater fraction of the bandwidth of the channel than is occupied by the optical signal in a conventional optical WDM communication system. The spread-spectrum optical signal occupying a larger than normal fraction of the bandwidth of the optical channel causes inter-channel interference, but such interference not prevent the original information signals from being recovered at the receiver.

Moreover, each optical channel of the optical WDM communication system in accordance with the invention is able to transmit a greater cumulative bit rate than the optical channels of a conventional optical WDM communication system because the channel is able to carry more than L spread-spectrum information signals. Processes for dividing an input information signal of a given bit rate into multiple information signals each having a lower bit rate are known in the art.

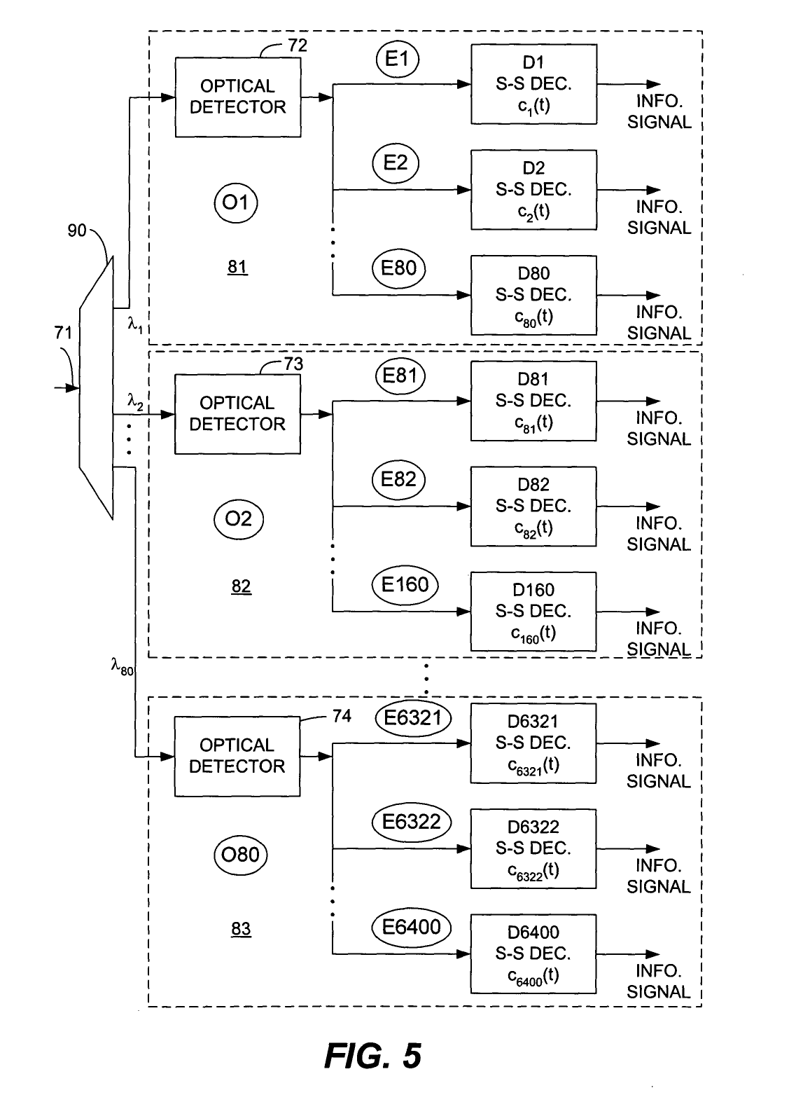

FIG. 5 is a block diagram of the receiver portion 80 of an optical communication system the invention in accordance with an exemplary embodiment that receives the spread-spectrum optical signals transmitted over fiber 71 by transmitter portion 50 (FIG. 4) in optical channels O1-O80. FIG. 5 shows optical receivers 81, 82 and 83 of optical channels O1, O2 and O80, respectively. The ellipses between the optical receivers 82 and 83 represent the optical receivers for optical channels O3-O79 that have been omitted to simplify the drawing.

The optical receiver 81 is composed of the optical detector 72 and the spread-spectrum decoders D1, D2, . . . , D80 of the electrical channels E1, E2, . . . , E80. The spread-spectrum decoders of electrical channels E3-E79 have been omitted to simplify the drawing. The optical receiver 82 is composed of the optical detector 73 and the spread-spectrum decoders D81, D82, . . . , D160 of the electrical channels E81, E82, . . . , E160. The optical receiver 83 is composed of the optical detector 73 and the spread-spectrum decoders D6321, D6322, . . . , D6400 of the electrical channels E6321, E6322, . . . , E6400. The spread-spectrum decoders of electrical channels E6323-E6399 have been omitted to simplify the drawing.

In each of the optical receivers 81, 82, . . . , 83, the spread-spectrum decoders decode the spread-spectrum information signals generated in same-numbered electrical channels of the transmitter portion 50 shown in FIG. 4 using the same PN code sequences to recover a corresponding one of the information signals.

At the receiver 80, the WDM optical signal received via optical fiber 71 is demultiplexed by optical demultiplexer 90 into the single-wavelength spread-spectrum optical signals of optical channels O1, O2, . . . , O80. The single-wavelength spread-spectrum optical signals are fed to the respective optical receivers 81, 82, . . . , 83. In the optical receiver 81, the optical detector 72 converts the spread-spectrum optical signal into a spread-spectrum electrical signal. The spread-spectrum electrical signal represents spread-spectrum information signals corresponding in number to the number of information signals received by the spread-spectrum encoders of the optical channel O1 in the transmitter portion 50 (FIG. 4), i.e., as many as eighty information signals in this example.

The optical detector 72 feeds the spread-spectrum electrical signal generated in response to the spread-spectrum optical signal of wavelength λ₁ in optical channel O1 to the spread-spectrum decoders D1 through D80. Each of the spread-spectrum decoders D1 through D80 is similar in structure to the spread-spectrum decoder 47 described above with reference to FIG. 3. However, the spread-spectrum decoders D1 through D80 of optical receiver 81 are assigned mutually orthogonal or pseudo-orthogonal PN code sequences c₁(t) through c₈₀(t), as described above. Each of the spread-spectrum decoders performs the decoding function described above with respect to FIG. 3 and outputs an electrical signal that represents a respective one of the original information signals. The electrical signals output by the spread-spectrum decoders D1, through D80 represent the information signals received by electrical channels E1 through E80, respectively, of the transmitter portion 50 (FIG. 4). The ellipses between the spread-spectrum decoders D2 and D80 represent the spread-spectrum decoders D3 through D79 that have been omitted to simplify the drawing.

The single-wavelength spread-spectrum optical signal of optical channel O2 output by optical demultiplexer 90 is fed to the optical receiver 82. In the optical receiver 82, the optical detector 73 converts the spread-spectrum optical signal to a spread-spectrum electrical signal that is fed to the spread-spectrum decoders D81 through D160. Each of the spread-spectrum decoders D81 through D160 is similar in structure to the spread-spectrum decoder 47 described above with reference to FIG. 3. However, the spread-spectrum decoders D81 through D160 are assigned PN code sequences c₈₁(t) through c₁₆₀(t) that are mutually orthogonal or pseudo-orthogonal, and are also orthogonal or pseudo-orthogonal to the PN code sequences assigned to the electrical channels of optical channels O1 and O3, as described above. The electrical signals output by the spread-spectrum decoders D81 through D160 represent the information signals received by electrical channels E81, . . . , E160, respectively, of the transmitter portion 50 (FIG. 4). The ellipses between the spread-spectrum decoders D82 and D160 represent the spread-spectrum decoders D83 through D159 that have been omitted to simplify the drawing.

The single-wavelength spread-spectrum optical signal of optical channel O80 output by optical multiplexer 90 is fed to the optical receiver 83. In the optical receiver 83, the optical detector 74 converts the spread-spectrum optical signal to a spread-spectrum electrical signal that is fed to the spread-spectrum decoders D6321 through D6400. The spread-spectrum decoders D6321 through D6400 are similar in structure to the spread-spectrum decoder 47 described above with reference to FIG. 3. However, the spread-spectrum decoders D6321 through D6400 are assigned PN code sequences c₆₃₂₁(t) through c₆₄₀₀(t) that are mutually orthogonal or pseudo-orthogonal and are also orthogonal or pseudo-orthogonal to the PN code sequences assigned to the electrical channels of optical channel O79, as described above. The electrical signals output by the spread-spectrum decoders D6321 through D6400 represent the information signals received by electrical channels E6321 through E6400, respectively, of the transmitter portion 50 (FIG. 4). The ellipses between the spread-spectrum decoders D6322 and D6400 represent the spread-spectrum decoders of electrical channels E6323 through E6399 that have been omitted to simplify the drawing.

The block diagrams shown in FIGS. 4 and 5 are not intended to illustrate comprehensive implementation details of the optical transmitter and the optical receiver of an optical WDM communication system in accordance with the invention. The block diagrams shown in FIGS. 4 and 5 are intended to illustrate examples of configurations of the optical transmitter and the optical receiver of such optical WDM communication system. Moreover, other circuitry may be incorporated into the transmitter and receiver for other purposes. For example, the receiver may include circuits for performing clock recovery, pulse shaping and other operations. These functions and the circuitry for performing them are not described herein in the interest of brevity. As stated above, the optical transmitters may include symbol generators for converting the information signals into symbols and other circuits for performing coding for error detection/correction and circuits for performing interleaving. In that case, the optical receivers would also include circuits for decoding the symbols, performing error detection and correction and de-interleaving.

In the exemplary embodiment of an optical receiver shown in FIG. 5, each of the optical receivers 81, 82, . . . 83 includes a single optical detector 72, 73, . . . , 74, respectively. In another embodiment, each of the optical receivers includes an optical splitter that optically distributes the single-wavelength spread-spectrum optical signal to the electrical channels of the optical channel. In this embodiment, each electrical channel includes an optical detector similar to the optical detectors 72, 73 and 74. In an example in which each spread-spectrum optical signal represents 80 electrical channels, the optical receiver 81 includes an 80-way optical splitter (not shown) arranged to receive the spread-spectrum optical signal for optical channel O1 output by optical demultiplexer 90. The optical splitter divides the spread-spectrum optical signal into 80 spread-spectrum optical signals of the same wavelength, and the 80 spread-spectrum optical signals are each distributed to a respective one of the electrical channels E1 through E80. Each of the electrical channels E1 through E80 includes an optical detector that receives the respective spread-spectrum optical signal and converts the spread-spectrum optical signal to a spread-spectrum electrical signal. The spread-spectrum electrical signal is decoded by the spread-spectrum decoder of the electrical channel as described above. The remaining optical receivers are similarly structured.

In a further embodiment, the optical receiver 81 includes an optical splitter and a number of optical detectors intermediate between unity and the number of electrical channels in the optical receiver. The optical splitter optically distributes the single-wavelength spread-spectrum optical signal to the optical detectors. The spread-spectrum electrical signal generated by each optical detector is then distributed electrically to a subset of the spread-spectrum decoders of the optical channel. In one example, the optical splitter optically distributes the spread-spectrum optical of optical channel O1 to ten optical detectors and the electrical output of each optical detector is electrically distributed to eight of the spread-spectrum decoders of the optical receiver 81. The remaining optical receivers are similarly structured.

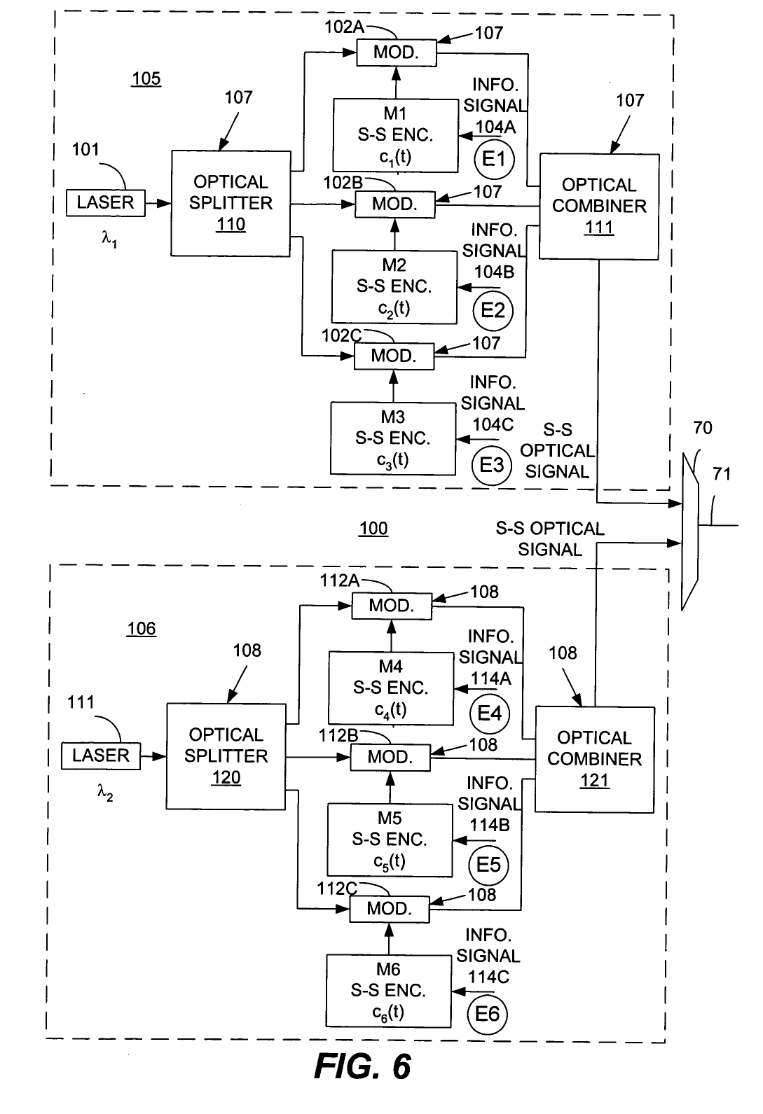

FIG. 6 is a block diagram illustrating another exemplary embodiment of a transmitter portion 100 of an optical communication system in accordance with the invention. In this embodiment, the spread-spectrum signals are summed in the optical domain instead of in the electrical domain. To simplify the drawing, FIG. 6 shows a highly simplified embodiment of the transmitter portion 100 composed only of the optical transmitters 105 and 106 of the two optical channels O1 and O2 and an optical multiplexer 70. In the highly simplified embodiment shown, the optical transmitter 105 includes the three spread-spectrum encoders M1-M3 of electrical channels E1-E3, respectively and the optical transmitter 106 includes the three spread-spectrum encoders M4-M6 of electrical channels E4-E6, respectively.

The optical transmitter 105 of optical channel O1 is composed of a laser 101, a modulator system 107 and spread-spectrum encoders M1-M3. In this embodiment, the modulator system 107 is composed of an optical splitter 110, modulators 102A, 102B and 102C and an optical combiner 111. The modulator system 107 modulates light generated by the laser 101 in response to the spread-spectrum information signals generated by the spread-spectrum encoders M1-M3 to generate a spread-spectrum optical signal for transmission. The spread-spectrum optical signal has an amplitude modulation representative of the sum of the spread-spectrum information signals generated by spread-spectrum encoders M1-M3.

In optical transmitter 105, the laser 101 generates a CW laser beam having wavelength λ₁. The optical splitter 110 splits the laser beam into three beams of light of wavelength λ₁. Preferably, the beams are of equal power. The three beams of light output by optical splitter 110 are received by modulators 102A, 102B and 102C.

In electrical channels E1, E2 and E3, spread-spectrum encoders M1, M2 and M3 respectively multiply information signals 104A, 104B and 104C by respective PN code sequences c₁(t), c₂(t) and c₃(t) to generate respective spread-spectrum information signals. The spread-spectrum information signals fed to the modulator system 107 where they are received by modulators 102A, 102B and 102C. The modulators additionally receive respective light beams from the optical splitter 110. Each modulator modulates a respective one of the light beams in response to a respective one of the spread-spectrum information signals to provide a respective spread-spectrum optical signal component. The spread-spectrum optical signal components pass to the optical combiner 111.

The optical combiner 111 receives the spread-spectrum optical signal components and spatially overlaps them to provide the spread-spectrum optical signal for optical channel O1. The optical combiner 111 feeds the spread-spectrum optical signal for optical channel O1 to optical multiplexer 70 for transmission over optical fiber 71.

The optical transmitter 106 of optical channel O2 is composed of a laser 111, a modulator system 108 and spread-spectrum encoders M4-M6. In this embodiment, the modulator system 108 is composed of an optical splitter 120, modulators 112A, 112B and 112C and an optical combiner 121. The modulator system 108 modulates light generated by the laser 111 in response to the spread-spectrum information signals generated by the spread-spectrum encoders M4-M6 to generate a spread-spectrum optical signal for transmission. The spread-spectrum optical signal has an amplitude modulation representative of the sum of the spread-spectrum information signals generated by spread-spectrum encoders M4-M6.

In the optical transmitter 106, the laser 111 generates a CW laser beam having wavelength λ₁. The optical splitter 120 splits the laser beam into three beams of light of wavelength λ₂. Preferably, the beams are of equal power. The three beams of light are received by modulators 112A, 112B and 112C.

In electrical channels E4, E5 and E6, spread-spectrum encoders M4, M5 and M6 respectively multiply information signals 114A, 114B and 114C by respective PN code sequences c₄(t), c₅(t) and c₆(t) to generate respective spread-spectrum information signals. The spread-spectrum information signals are fed to modulator system 108, where they are received by modulators 112A, 112B and 112C. The modulator additionally receive respective light beams from the optical splitter 120. Each modulator modulates a respective one of the light beams in response to a respective one of the spread-spectrum information signals to provide a respective spread-spectrum optical signal component. The spread-spectrum optical signal components pass to the optical combiner 121.

The optical combiner 121 receives the spread-spectrum optical signal components and spatially overlaps them to provide the spread-spectrum optical signal for optical channel O2. The optical combiner 121 feeds the spread-spectrum optical signal for optical channel O2 to multiplexer 70.

The multiplexer 70 optically multiplexes the spread-spectrum optical signals output by the optical combiners 111 and 121 at wavelengths λ₁ and λ₂ for transmission over optical fiber 71.

In the transmitter portion 100, the number of optical transmitters and the number of electrical channels in each optical transmitter may be different from, and is typically substantially larger than, the number of optical transmitters and the number of electrical channels in each optical transmitter in the example just described.

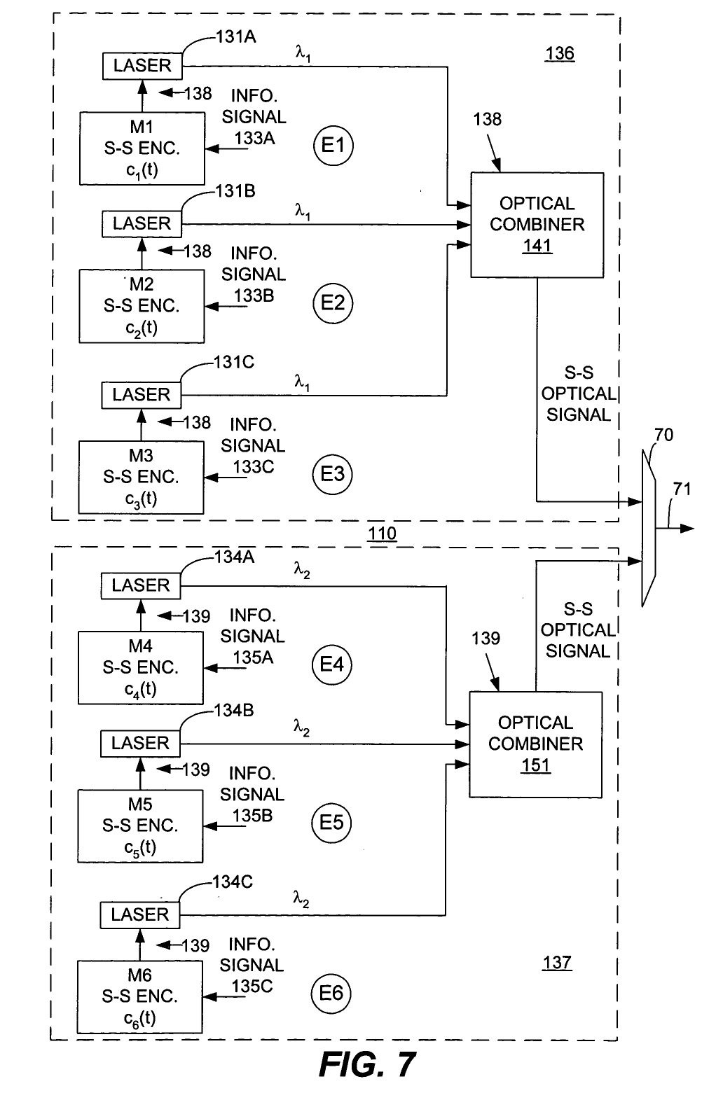

FIG. 7 is a block diagram illustrating another exemplary embodiment of a transmitter portion 110 of an optical communication system in accordance with the invention. As in the transmitter portion embodiment shown in FIG. 6, the spread-spectrum information signals are summed in the optical domain instead of in the electrical domain in the transmitter portion embodiment shown in FIG. 7. To simplify the drawing, FIG. 7 shows a highly simplified embodiment of the transmitter portion 110 composed of the optical transmitters 136 and 137 of only two optical channels O1 and O2 and the optical multiplexer 70. In the highly simplified embodiment shown, the optical transmitter 136 includes the three spread-spectrum encoders M1-M3 of electrical channels E1-E3, respectively, and the optical transmitter 137 includes the three spread-spectrum encoders M4-M6 of electrical channels E4-E6, respectively. In this embodiment, each spread-spectrum information signal directly modulates a respective laser.

The optical transmitter 136 of optical channel O1 is composed of lasers 131A, 131B and 131C, a modulator system 138 and spread-spectrum encoders M1-M3. Each of the lasers generates light at the same wavelength, i.e., λ₁, and includes a modulation input. The modulator system 138 is composed of an optical combiner 141 and electrical conductors connecting the spread-spectrum information signals from the spread-spectrum encoders M1-M3 to the modulation inputs of the lasers 131A, 131B and 131C, respectively. The modulator system 138 modulates light generated by the lasers 131A, 131B and 131C in response to the spread-spectrum information signals generated by the spread-spectrum encoders M1-M3 to generate a spread-spectrum optical signal for transmission. The spread-spectrum optical signal has an amplitude modulation representative of the sum of the spread-spectrum information signals generated by spread-spectrum encoders M1-M3.

In the optical transmitter 136 for optical channel O1, in electrical channels E1, E2 and E3, the spread-spectrum encoders M1, M2 and M3 multiply the information signals 133A, 133B and 133C by respective PN code sequences c₁(t), c₂(t) and c₃(t) to generate respective spread-spectrum information signals. The spread-spectrum information signals are connected by respective electrical conductors to the modulation inputs of lasers 131A, 131B and 131C, respectively. The spread-spectrum information signals directly modulate the lasers to generate respective spread-spectrum optical signal components. The spread-spectrum optical signal components pass to the optical combiner 141. The optical combiner 141 receives the spread-spectrum optical signal components and spatially overlaps the spread-spectrum optical signal components to provide the spread-spectrum optical signal for optical channel O1. The optical combiner 141 provides the spread-spectrum optical signal for optical channel O2 to the optical multiplexer 70.

The optical transmitter 137 of optical channel O2 is composed of lasers 134A, 134B and 134C, a modulator system 139 and spread-spectrum encoders M4-M6. Each of the lasers generates light at the same wavelength, i.e., λ2, and includes a modulation input. The modulator system 139 is composed of an optical combiner 151 and electrical conductors connecting the spread-spectrum information signals from the spread-spectrum encoders M4-M6 to the modulation inputs of the lasers 134A, 134B and 134C, respectively. The modulator system 139 modulates light generated by the lasers 134A, 134B and 134C in response to the spread-spectrum information signals generated by the spread-spectrum encoders M4-M6 to generate a spread-spectrum optical signal for transmission. The spread-spectrum optical signal has an amplitude modulation representative of the sum of the spread-spectrum information signals generated by spread-spectrum encoders M4-M6.

In the optical transmitter 137 of optical channel O2, in electrical channels E4, E5 and E6, the spread-spectrum encoders M4, M5 and M6 multiply the information signals 135A, 135B and 135C by respective PN code sequences c₄(t), c₅(t) and c₆(t) to generate respective spread-spectrum information signals. The spread-spectrum information signals are connected by respective electrical conductors to the modulation inputs of lasers 134A, 134B and 134C, respectively. The spread-spectrum information signals directly modulate the lasers to generate respective spread-spectrum optical signal components. The spread-spectrum optical signal components pass to optical combiner 151. The optical combiner 151 receives the spread-spectrum information signal components and spatially overlaps the spread-spectrum optical signal components to provide the spread-spectrum optical signal for optical channel O2. The optical combiner 151 provides the spread-spectrum optical signal for optical channel O2 to the optical multiplexer 70. The optical multiplexer multiplexes the spread-spectrum optical signals for optical channels O1 and O2 output by optical combiners 141 and 151 for transmission over optical fiber 71.

In another embodiment, each of lasers 131A, 131B and 131C and 134A, 134B and 134C generate a respective continuous-wave light beam that is modulated by a respective modulator (not shown) in response to the respective spread-spectrum information signal.

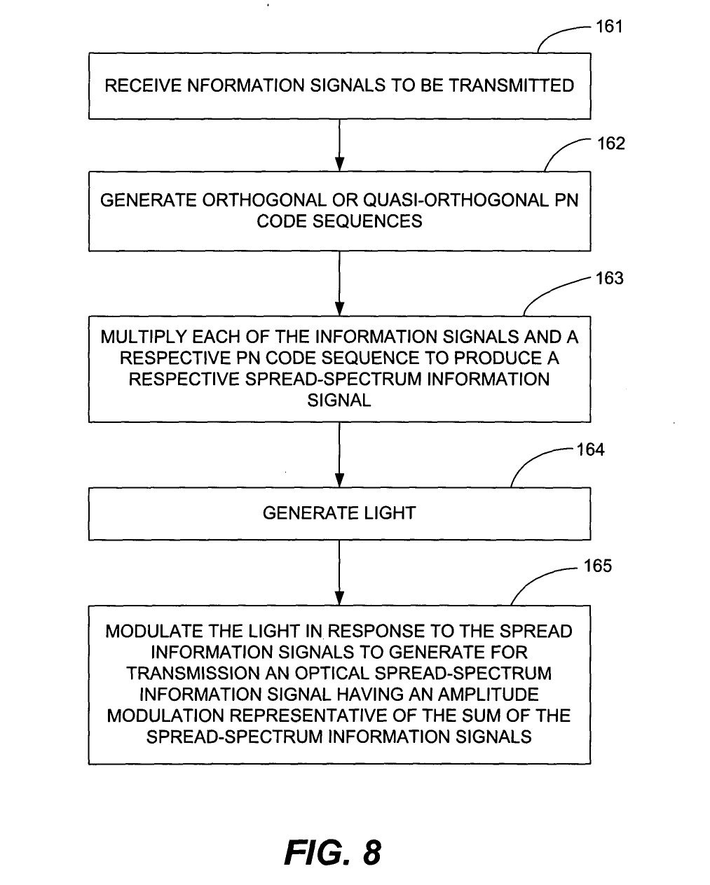

An aspect of an optical communication method in accordance with the invention will now be described. In the optical communication method, processes including a spread-spectrum optical signal generating process are performed. FIG. 8 is a flow chart illustrating the spread-spectrum optical signal generating process in accordance with the invention. In block 161, information signals are received. In block 162, orthogonal or quasi-orthogonal pseudo-noise (PN) code sequences are generated. In block 163, each of the information signals is multiplied by a respective one the PN code sequences to generate a respective spread-spectrum information signal. In block 164, light is generated. In block 165, the light is modulated in response to the spread-spectrum information signals to generate for transmission a spread-spectrum optical signal having an amplitude modulation representative of the sum of the spread-spectrum information signals.

It should be noted that the processes represented by the blocks shown in FIG. 8 can be performed an order different from that just described. For example, the light can be generated before any of the processes represented by blocks 161, 162 and 163 are performed. Some of the processes can be performed simultaneously.

Information signals transmitted on the same optical channel are multiplied by mutually orthogonal or quasi-orthogonal PN code sequences to distinguish the resulting spread-spectrum information signals from one another. Information signals transmitted in immediately adjacent optical channels are also multiplied by orthogonal or quasi-orthogonal PN code sequences to enable the spread-spectrum information signals in each of the optical channels to be distinguished from one another and from inter channel interference caused by the spread-spectrum optical signals transmitted in the adjacent optical channel. The level of inter-channel interference is relatively high in an optical WDM communication system in accordance with the invention. Conservatively designed optical WDM communication systems will use mutually orthogonal or quasi-orthogonal PN code sequences in more than the immediately-adjacent optical channels. The same PN code sequences may be used in optical channels that are relatively remote from one another, depending on the maximum level of inter-channel interference permitted among the optical channels.

In an embodiment of the optical communication method described above, additional ones of the spread-spectrum optical signal generating process described above with reference to FIG. 8 are performed to generate respective spread-spectrum optical signals having different carrier wavelengths. The spread-spectrum optical signals having the different carrier wavelengths are then subject to wavelength division multiplexing to generate a wavelength-division multiplexed optical signal for transmission.

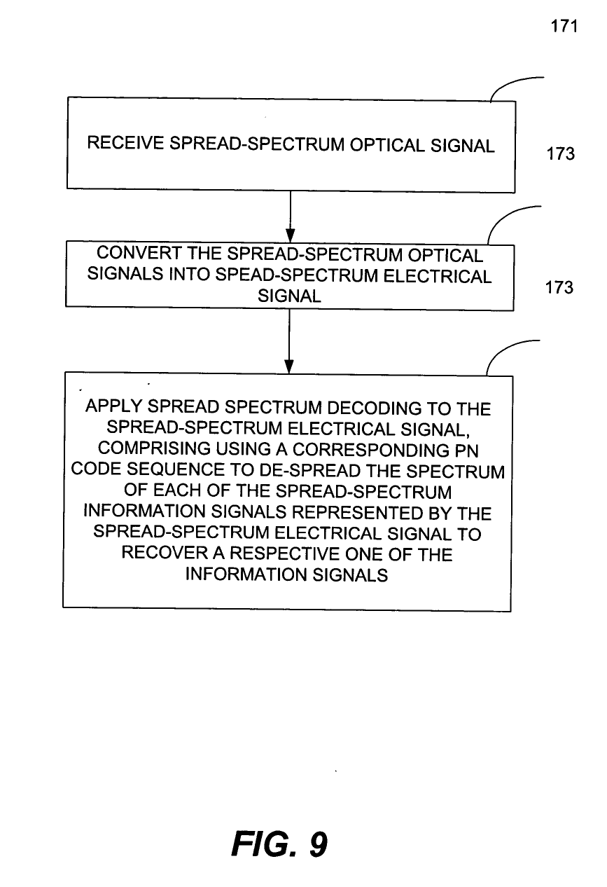

Another aspect of the optical communication method in accordance with the invention will now be described. In the optical communication method, processes including a spread-spectrum optical signal receiving process are performed. FIG. 9 is a flow chart illustrating the spread-spectrum optical signal receiving process in accordance with the invention. In block 171, a spread-spectrum optical signal is received. The spread-spectrum optical signal represents spread-spectrum information signals each of which has a spectrum spread by a respective pseudo-noise (PN) code sequence. In block 172, the spread-spectrum optical signal is converted into a spread-spectrum electrical signal. In block 173, spread-spectrum decoding is applied to the spread-spectrum electrical signal. The spread-spectrum decoding includes using a corresponding PN code sequence to despread the spectrum of each of the spread-spectrum information signals represented by the spread-spectrum electrical signal to recover a respective one of the information signals.

In an embodiment of the optical communication method, a WDM optical signal composed of spread-spectrum optical signals having respective different carrier wavelengths is received. The WDM optical signal is demultiplexed to recover the spread-spectrum optical signals and the above-described spread-spectrum optical signal receiving process is performed on each of the spread-spectrum optical signals. The spread-spectrum optical signal receiving processes may be performed serially or in parallel.

It should be noted that the invention has been described with reference to certain exemplary embodiments and that the invention is not limited to these embodiments. The invention can be implemented in a variety of ways and is not limited to the embodiments described herein. Many variations can be made to the embodiments described herein that are within the scope of the invention.

For example, some of the figures depict multiple circuits that perform the same operation on different signals. Some of these circuits may be replaced by a single circuit that processes the signals sequentially. Similarly, some of the figures depict a single circuit that operates on different signals. The different signals may alternatively be individually processed by separate circuits. Also, the method can also be implemented in software, in which case, all elements need not exist simultaneously.

1. An optical communication system for communicating one or more information signals, the optical communication system comprising an optical transmitter, the optical transmitter comprising:
spread-spectrum encoders corresponding in number to the information signals, the spread-spectrum encoders operable to multiply the information signals by respective pseudo-noise (PN) code sequences to generate respective spread-spectrum information signals;
a light source; and
modulator means for modulating light generated by the light source in response to the spread-spectrum information signals to generate a spread-spectrum optical signal for transmission, the spread-spectrum optical signal having an amplitude modulation representative of the sum of the spread-spectrum information signals.

2. The optical communication system of claim 1, wherein the modulator means comprises:
an analog summer connected to receive the spread-spectrum information signals from the spread-spectrum encoders and operable to sum the spread-spectrum information signals to provide a modulation signal; and
a modulator connected to receive the light and the modulation signal, and operable to modulate the light in response to the modulation signal to generate the spread-spectrum optical signal.

3. The optical communication system of claim 1, wherein the modulator means comprises:
modulators each connected to receive the light and a respective one of the spread-spectrum information signals and operable to modulate the light in response to the one of the spread-spectrum information signals to provide a spread-spectrum optical signal component; and
an optical combiner arranged to receive the spread-spectrum optical signal components from the modulators and operable to spatially overlap the spread-spectrum optical signal components to generate the spread-spectrum optical signal.

4. The optical communication system of claim 3, wherein the light source comprises lasers corresponding in number to the information signals.

5. The optical communication system of claim 1, wherein:
the light source comprises lasers corresponding in number to the information signals, the lasers each comprising a modulation input; and
the modulator means comprises:
electrical conductors arranged to connect the spread-spectrum information signals from the spread-spectrum encoders to the modulation inputs of respective ones of the lasers and operable to cause the spread-spectrum information signals to modulate the light generated by the lasers to provide respective spread-spectrum optical signal components, and
an optical combiner arranged to receive the spread-spectrum optical signal components and operable to spatially overlap them to generate the spread-spectrum optical signal.

6. The optical communication system of claim 1, wherein:
the optical communication system additionally comprises additional ones of the optical transmitters;
the light sources of the optical transmitters generate light at mutually different wavelengths; and
the optical communication system additionally comprises a wavelength division multiplexer connected to receive the spread-spectrum optical signals from the optical transmitters and operable to multiplex the spread-spectrum optical signals for transmission.

7. The optical communication system of claim 6, wherein the PN code sequences used in each of the transmitters are all orthogonal or quasi-orthogonal to each other.

8. The optical communication system of claim 7, wherein the PN code sequences are all orthogonal or quasi-orthogonal to each other at least in pairs of the optical transmitters of adjacent optical channels.

9. The optical communication system of claim 1, wherein the PN code sequences are all orthogonal or quasi-orthogonal to each other.

10. The optical communication system of claim 1, wherein the spread-spectrum encoder comprises:
a code sequence generator configured to generate a PN code sequence; and
a multiplier connected to receive one of the information signals and the respective PN code sequence, the multiplier operable to multiply the one of the information signals by the respective PN code sequence to produce the respective spread-spectrum information signal.

11. An optical communication system for communicating one or more information signals, the optical communication system comprising an optical receiver, the optical receiver comprising:
an optical detector arranged to receive a spread-spectrum optical signal representing at least one spread-spectrum information signal, each spread-spectrum information signal having a spectrum spread by a respective pseudo-noise (PN) code sequence, the optical detector operable to generate a spread-spectrum electrical signal in response to the spread-spectrum optical signal; and
at least one spread-spectrum decoder connected to receive the spread-spectrum electrical signal from the optical detector, each spread-spectrum decoder operable to despread the spectrum of one of the spread-spectrum information signals represented by the spread-spectrum electrical signal to recover a corresponding information signal.

12. The optical communication system of claim 11, wherein the spread-spectrum decoder comprises:
a code acquisition circuit connected to receive the spread-spectrum electrical signal and a PN code sequence corresponding to the PN code sequence used to encode one of the spread-spectrum information signals, the code acquisition circuitry operable to align the PN code sequence with the one of the spread-spectrum information signals in the spread-spectrum electrical signal;
a multiplier connected to receive the spread-spectrum electrical signal from the optical receiver and the aligned PN code sequence from the code acquisition circuitry, the multiplier operable to multiply the spread-spectrum electrical signal by the aligned PN code sequence to generate a despread information signal; and
integrating and thresholding circuits connected to receive the despread information signal from the multiplier and operable to recover the information signal from the despread information signal.

13. The optical communication system of claim 12, wherein the code acquisition circuitry comprises a cross-correlator.

14. The optical communication system of claim 11, further comprising:
a wave-division demultiplexer arranged to receive a WDM optical signal, the WDM optical signal comprising spread-spectrum optical signals having mutually different carrier wavelengths, the wave-division demultiplexer operable to spatially separate the spread-spectrum optical signals constituting the WDM optical signal from one another; and
additional ones of the optical receivers, the optical receivers being arranged each to receive a different one of the spread-spectrum optical signals from the wave-division demultiplexer.

15. The optical communications system of claim 14, wherein the PN code sequences used to spread the spectra of the spread-spectrum information signals are all orthogonal or quasi-orthogonal to each other.

16. The optical communications system of claim 14, wherein the PN code sequences used to spread the spectra of the spread-spectrum information signals represented by ones of the spread-spectrum optical signals in adjacent optical channels are all orthogonal or quasi-orthogonal to each other.

17. An optical communication method, comprising performing a spread-spectrum optical signal generating process, the spread-spectrum optical signal generating process comprising:
receiving information signals;
generating orthogonal or quasi orthogonal pseudo-noise (PN) code sequences;
multiplying each of the information signals by a respective one of the PN code sequences to generate a respective spread-spectrum information signal;
generating light; and
modulating the light in response to the spread-spectrum information signals to generate for transmission a spread-spectrum optical signal having an amplitude modulation representative of the sum of the spread-spectrum information signals.

18. The optical communication method of claim 17, wherein the modulating comprises:
summing the spread-spectrum information signals to provide a modulation signal; and
modulating the light in response to the modulation signal to generate the spread-spectrum optical signal.

19. The optical communication method of claim 17, wherein the modulating comprises:
individually modulating the light in response to each one of the spread-spectrum information signals to provide a spread-spectrum optical signal component; and
spatially overlapping the spread-spectrum optical signal components to generate the spread-spectrum optical signal.

20. The optical communication method of claim 17, wherein:
the optical communication method additionally comprises performing additional ones of the spread-spectrum optical signal generating process to generate respective spread-spectrum optical signals having different carrier wavelengths; and
wavelength division multiplexing the spread-spectrum optical signals having the different carrier wavelengths to generate a wavelength-division multiplexed optical signal for transmission.

21. An optical communication method, comprising performing a spread-spectrum optical signal receiving process, the spread-spectrum optical signal receiving process comprising:
receiving a spread-spectrum optical signal representing spread-spectrum information signals, each spread-spectrum information signal having a spectrum spread by a respective pseudo-noise (PN) code sequence;
converting the spread-spectrum optical signal to a spread-spectrum electrical signal; and
applying spread-spectrum decoding to the spread-spectrum electrical signal, comprising using a corresponding PN code sequence to despread the spectrum of each of the spread-spectrum information signals represented by the spread-spectrum electrical signal to recover a respective one of the information signals.

22. The optical communication method of claim 21, additionally comprising:
receiving a WDM optical signal comprising spread-spectrum optical signals having respective different carrier wavelengths;
demultiplexing the WDM optical signal to recover the spread-spectrum optical signals; and
performing the spread-spectrum optical signal receiving process on each of the spread-spectrum optical signals.
